(19) United States
(12) Patent Application Publication
(10) Pub. No.: US 2009/0147972 A1
(43) Pub. Date: Jun. 11, 2009

(54) HYBRID SPEAKER

(76) Inventor: Kyung Hwan Hwang, Gyeonggi-province (KR)

Correspondence Address: RABIN & Berdo, PC, 1101 14TH STREET, NW, SUITE 500, WASHINGTON, DC, 20005, US

(21) Appl. No.: 11/719,648

(22) PCT Filed: Dec. 21, 2004
(86) PCT No.: PCT/KR04/03367

§ 371 Date: May 17, 2007

(30) Foreign Application Priority Data
Nov. 18, 2004 (KR) 10-2004-0094545

(51) Int. Cl. H04R 25/00

(52) U.S. Cl. 381/190

(57) ABSTRACT

Provided is a hybrid speaker including a vibration diaphragm having a conductive coating layer formed by coating a conductive material for forming an electrode on a surface of a polymer film and an aerogel layer formed by coating aerogel on the other surface of the polymer film, a piezo element disposed at a surface of the vibration diaphragm, forming opposite poles with the vibration diaphragm, and generating sound pressure by a piezoelectric effect, a PCB electrically connected to the vibration diaphragm and the piezo element and applying an external AC voltage, a first insulation body disposed on the other surface of the vibration diaphragm opposite to the piezo element, and a case accommodating and fixing the above constituent elements and having a sonnd pressure discharge hole in a surface thereof.

### TECHNICAL FIELD

The present invention relates to a hybrid speaker, and more particularly, to a hybrid speaker using a phenomenon in which, when a high AC voltage is applied, a metal plate vibrates by a coulomb force (an electric force between charges).

### BACKGROUND ART

In general, as speakers are manufactured with new materials, although the speakers themselves are made smaller and thinner, the quality of sound is gradually deteriorated. In the meantime, the sound quality of a condenser type speaker is superb that cannot be obtained in other methods so that a user can enjoy the quality sound which can be created in a professional sound recording studio.

FIG. 1 illustrates an example of the condenser type speaker. Referring to FIG. 1, the condenser type speaker includes fixed pole plates 1a and 1b and a vibration diaphragm 2 and utilizes a phenomenon of the vibration diaphragm 2 vibrating when a high AC voltage is applied to a metal plate by a coulomb force.

That is, the vibration diaphragm 2 and the fixed pole plates 1a and 1b are installed to face one another. After a high voltage is applied to form an electrostatic field, when a voice signal is applied to the first side of a modulation transformer 3, a change in voltage generates a change in electrostatic charge. Thus, sound is generated as the vibration diaphragm 2 and the fixed pole plates 1a and 1b push and pull one another.

The vibration diaphragm 2 is made by coating metal on a plastic thin film and has a thickness of 10-20 mm. Thus, the vibration diaphragm 2 is advantageous in reproducing tender sound, in particular, a high frequency band, and capable of covering the entire audio frequency range with a single speaker.

However, a large area is needed to reproduce a low frequency. Also, since sound pressure is low, the vibration diaphragm 2 is not appropriate for reproducing loud sound. That is, an additional means is required to cover a low frequency band and a large area of the vibration diaphragm 2 is needed to manufacture a high power speaker.

To solve the above problems, the present applicant has filed Korean Patent Application No. 10-2004-0018659 disclosing a technology regarding a condenser type speaker capable of outputting a high sound pressure in which two vibration plates, each of which is made by coating a conductive body on one surface of a polymer film, are installed to be separated from a pole plate. The thickness of the vibration plates are made different and an AC voltage is applied thereto so that a low frequency band or a high frequency band is compensated for. Thus, the sound quality in the entire frequency range is made superior and the condenser type speaker can be made compact.

As shown in FIGS. 2 and 3, the conventional condenser type speaker is formed by coating a conductive body for forming an electrode on one surface of a polymer film 220 and includes two lower and upper vibration plates 200 and 600, each having a ring 260 formed on a coating surface 240 for connecting the electrode and maintaining the shape of the polymer film 220, a pole plate 400 separated a predetermined distance from and between the lower and upper vibration plates 200 and 600 and having a protrusion 420 at the outer circumference thereof and a connection portion 440 vertically extending from the protrusion 420, an electric connection member 700 connected to the ring of the upper vibration plate 600, a PCB 800 electrically connected to the connection portion 440 and the electric connection member 700 and applying an external AC voltage to the lower and upper vibration plates 200 and 600 and the pole plate 400, an insulation body 100 having a protruding portion 120 formed outwardly, where an accommodation groove 140 to accommodate the protrusion 420 is formed, and an accommodation hole 160 formed at the center thereof, where the lower and upper vibration members 200 and 600, the pole plate 400, and the connection member 700 are accommodated, and a case 900 for accommodating and fixing the above parts and having a sound pressure discharge hole 920 is formed at the front surface thereof.

In the above structure, when an AC voltage is applied to the PCB 800 connected to the outside with the opposite poles of the lower and upper vibration plates 200 and 400 and the pole plate 400, the AC voltage is applied to the lower and upper vibration plates 200 and 400 and the pole plate 400. Thus, as the coating surface 240 of the vibration plate and a opposite-poles forming vibration plate of the pole plate 400 vibrate, sound pressure is generated. The sound pressure is discharged through the sound pressure discharge hole 920 formed in the case 900 so that sound is generated.

The thickness of the lower and upper vibration plates 200 and 600 can be made different to compensate for the low frequency band or high frequency band. Thus, the above two problems of the decrease in the low frequency band and the small power of sound which prevents miniaturization of the conventional condenser type speaker can be solved.

However, since the two lower and upper vibration plates 200 and 600 are needed and a complicated structure of the pole plate 400 and the insulation body 100 to electrically connect the two vibration plates and the PCB is needed, there is a limit in reducing the size of the condenser type speaker.

Also, a drive circuit to drive the condenser type speaker and a matching transformer to output a high impedance is additionally needed so that a circuit of an audio apparatus becomes complicated and the price thereof increases.

### DISCLOSURE OF INVENTION

### Technical Problem

To solve the above and/or other problems, the present invention provides a hybrid speaker having a simplified structure by using a single vibration plate and capable of compensating for a low frequency band by a damping effect of the vibration plate where an aerogel layer is formed so that sound quality in a lower frequency range is improved.

Also, the present invention provides a hybrid speaker which generates sound pressure sufficient for driving the hybrid speaker without an additional matching transformer or drive circuit so that the configuration of a circuit of an audio apparatus is simple and the price thereof is low.

The other objects and merits of the present invention will be described below and seen through embodiments of the present invention. Also, the objects and merits of the present invention can be realized by means and combination shown in the accompanying claims.

### Technical Solution

According to an aspect of the present invention, a hybrid speaker comprises a vibration diaphragm having a conductive coating layer formed by coating a conductive material for forming an electrode on a surface of a polymer film and an aerogel layer formed by coating aerogel on the other surface of the polymer film, a piezo element disposed at a surface of the vibration diaphragm, forming opposite poles with the vibration diaphragm, and generating sound pressure by a piezoelectric effect, a PCB electrically connected to the vibration diaphragm and the piezo element and applying an external AC voltage, a first insulation body disposed on the other surface of the vibration diaphragm opposite to the piezo element, and a case accommodating and fixing the above constituent elements and having a sound pressure discharge hole in a surface thereof.

The embodiments of the present invention will be described with reference to the accompanying drawings. Prior to the description, the terms and words used in the present specification and claims should not be interpreted to be typical or as dictionary meaning and should be interpreted as meaning and concept matching the technical concept of the present invention based on a principle in which the inventor can appropriately define the meaning of terms to describe one's own invention in the best way.

Thus, the embodiment described in the present application and the structure shown in the drawings are merely the most preferable embodiment of the present invention but do not represent all of the technical concept of the present invention. It must be understood that various equivalence which can replace the embodiment and modifications at the point of fling the present application.

### Advantageous Effects

According to the present invention, the structure of the speaker is simplified by using one vibration diaphragm. Also, a low frequency band is compensated and the sound quality in a low frequency band is improved, by a damping effect of the vibration diaphragm where the aerogel layer is formed.

Also, since a sound pressure sufficient to drive the hybrid speaker is generated, an additional matching transformer or drive circuit is not needed so that the circuit structure of an audio apparatus is simplified and the cost thereof is reduced.

### DESCRIPTION OF DRAWINGS

FIG. 1 is a view for explaining the principle of a conventional condenser type speaker;

FIGS. 2 and 3 are an exploded perspective view and an assembled cross-sectional view of the conventional condenser type speaker, respectively;

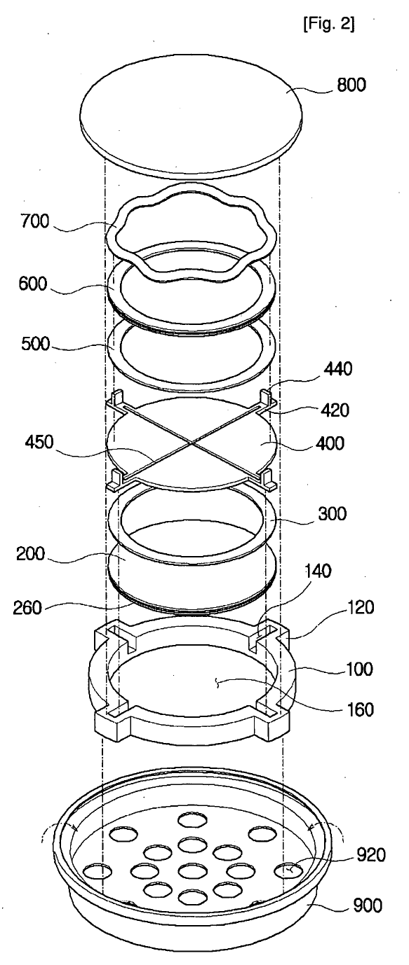

FIG. 4 is an exploded perspective view of a hybrid speaker according to an embodiment of the present invention;

FIG. 5 is a cross-sectional view of the hybrid speaker of FIG. 4 in an assembled state; and

FIG. 6 is a view illustrating a configuration of a vibration plate of FIG. 4.

### MODE FOR INVENTION

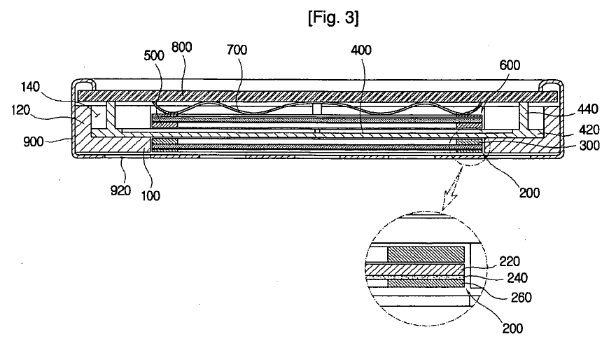

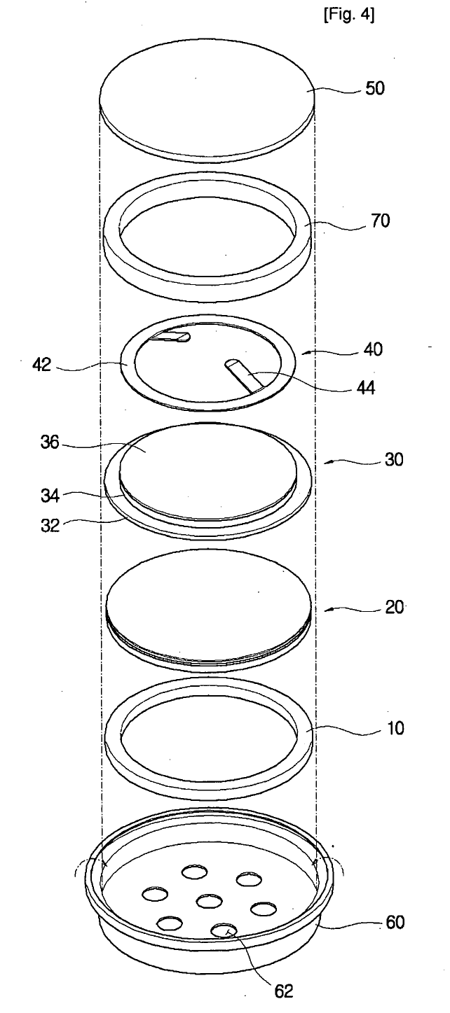

Referring to FIGS. 4 and 5, a hybrid speaker according to an embodiment of the present invention includes a first insulation body 10, a vibration diaphragm 20, a piezo element 30, a leaf spring 40, a PCB 50, a case 60, and a second insulation body 70.

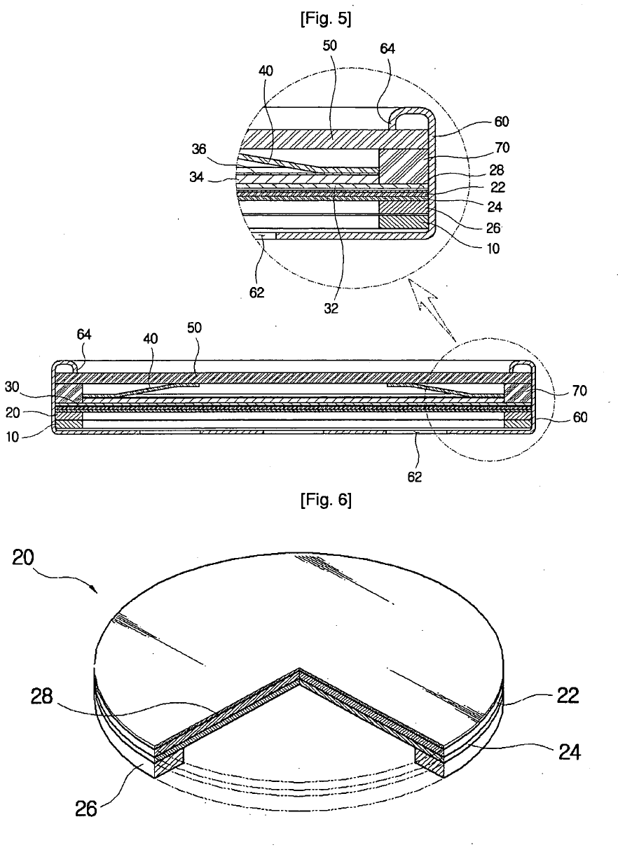

As shown in FIG. 6, in the vibration diaphragm 20, a conductive material for forming an electrode is coated on a surface of a polymer film 22 to form a conductive coating layer 24. A conductive ring 26 for connecting the electrode and maintaining the shape of the polymer film 22 is formed adjacent to the outer circumferential portion of the conductive coating layer 24. Aerogel is coated on the other surface of the polymer film 22 so that an aerogel layer 28 is formed.

The aerogel is a low density material exhibiting physical properties such as a low thermal conductivity, a low refractive index, and a high specific surface area and porosity, which is silica, carbon, or resorcinol-formaldehyde.

Silica aerogel applied to the present invention has an elasticity that is four times lower than that of silica glass and a sound speed c that is a sound transfer speed of 100 m/sec that is slower than air. Also, since the density ρ of the silica aerogel is very low, that is, 0.003 g/cm³, merely equivalent to about 3 times of the density of air, acoustic impedance Z=ρ, indicated as a multiplication of the sound speed by the density, is very low.

Therefore, by coating the aerogel having a low acoustic impedance preventing the flow of current on the polymer film 22, a low frequency band can be compensated for with the single vibration diaphragm 20 by a damping effect due to a frequency transmission property of the aerogel.

Next, referring to FIGS. 4 and 5, the piezo element 30 is disposed on the vibration diaphragm 20. The leaf spring 40 is disposed on the piezo element 30 so as to contact a pattern formed on a lower surface of the PCB 50.

The piezo element 30 utilizes a piezo effect in which a voltage is generated when pressure is received. When a voice signal is supplied by being changed into current, vibration (sound pressure) is generated according to the current.

The piezo element 30 is formed by attaching a copper plate 32 such as a brass plate on a surface of the piezoelectric device 34 such as crystal or ceramic and coating an electrode material on the other surface thereof, thus forming an electrode layer 36.

The conductive leaf spring 40 such as phosphor bronze copper is disposed on the electrode layer 36 so that the current of the PCB 50 is supplied to the piezo element 30.

The leaf spring 40 has a ring shape in which a plurality of contact protrusions 44 protruding from a lower surface 42 to the upper portion of the inside thereof are arranged to face each other. The lower surface 42 and the contact protrusions 44 contact the electrode layer 36 and the PCB 50, respectively.

The leaf spring 40 having a ring shape in which a space is formed at a center portion thereof allows sound pressure generated as the vibration diaphragm 20 and the piezo element 30 vibrate to be discharged so that smooth vibration is possible.

In FIGS. 4 and 5, the first insulation body 10 disposed on a lower surface of the vibration diaphragm 20 and has a ring shape having a space at the center portion thereof. The second insulation body 70 disposed on an upper surface of the piezo element 30 has a ring shape having a space at the center portion thereof. The leaf spring 40 is accommodated in the space of the second insulation body 70.

The PCB 50 is connected to the outside and has different patterns formed on the upper and lower surfaces thereof. The patterns formed on the upper and lower surfaces of the PCB 50 are connected to the vibration diaphragm 20 and the piezo element 30, respectively. That is, the conductive ring 26 of the vibration diaphragm 20 contacts the conductive case 60. A curled portion 64 of the case 60 is electrically connected to the upper surface of the PCB 50 so that the piezo element 30 is electrically connected to the lower surface of the PCB 50 through the conductive leaf spring 40.

According to the above electrical connection, an AC voltage can be applied to the piezo element 30 and the vibration diaphragm 20.

The case 60 is an injection-molded conductive metal material such as aluminum and has a plurality of sound pressure discharge holes 62 formed in the lower surface thereof. The upper portion of the case 60 is inwardly bent by curling in a state in which the above parts are all accommodated in the case 60, so that the parts are assembled not to move therein, thus manufacturing a hybrid speaker.

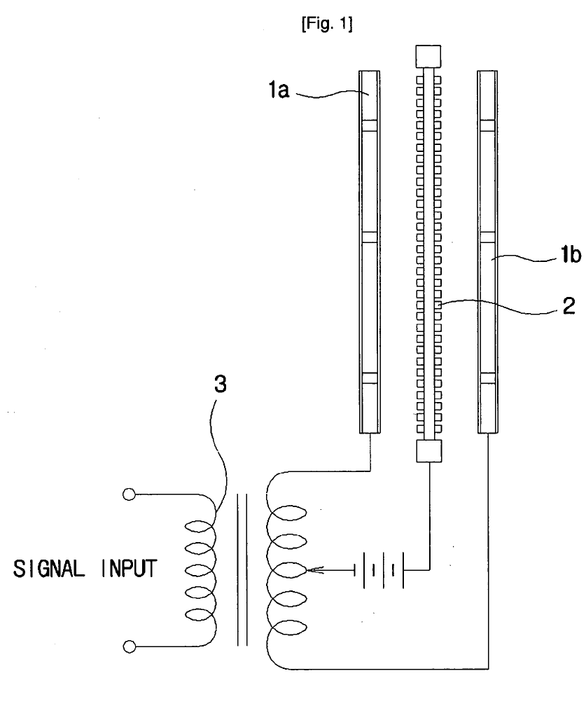

In the assembled state, when an AC voltage is applied to the PCB 50 connected to the outside with the opposite poles of the vibration diaphragm 20 and the piezo element 30, the AC voltage is applied to the piezo element 30 and the vibration diaphragm 20 and the conductive coating layer 24 of the vibration diaphragm 20 and the piezoelectric device 34 of the piezo element 30 vibrate according to the principle explained with reference to FIG. 1 so that sound pressure is generated. The leaf spring 40 vibrates up and down and the sound pressure is discharged through the sound pressure discharge holes 62 formed in the case 60 so that sound is generated.

In this case, the low frequency band can be compensated for by the frequency transmission property of the aerogel coated on the polymer film 22 of the vibration diaphragm 20.

Accordingly, the sound quality in the low frequency band can be improved by using the single vibration diaphragm 20. Also, since the only one vibration diaphragm 20 is electrically connected to the PCB 50, a complicated structure is not needed. Thus, the hybrid speaker can be made compact and the processing of mass-produces hybrid speakers is made easy.

Furthermore, since the piezo element 30 generates a sound pressure sufficient to drive the hybrid speaker, an additional matching transformer or drive circuit is not needed so that the circuit structure of an audio apparatus is simplified.

### INDUSTRIAL APPLICABILITY

The hybrid speaker according to the present invention can be used in the speaker manufacturing field. While this invention has been particularly shown and described with reference to preferred embodiments thereof, it will be understood by those skilled in the art that various changes in form and details may be made therein without departing from the spirit and scope of the invention as defined by the appended claims.

1. A hybrid speaker comprising:
a vibration diaphragm having a conductive coating layer formed by coating a conductive material for forming an electrode on a surface of a polymer film and an aerogel layer formed by coating aerogel on the other surface of the polymer film;
a piezo element disposed at a surface of the vibration diaphragm, forming opposite poles with the vibration diaphragm, and generating sound pressure by a piezoelectric effect;
a PCB electrically connected to the vibration diaphragm and the piezo element and applying an external AC voltage;
a first insulation body disposed on the other surface of the vibration diaphragm opposite to the piezo element; and
a case accommodating and fixing the above constituent elements and having a sound pressure discharge hole in a surface thereof;
wherein a conductive ring for connecting the electrode and maintaining the shape of the polymer film is formed on the conductive coating layer to contact the case.

2. (canceled)

3. The hybrid speaker of claim 1, wherein an upper portion of the case is bent inwardly by curling so that the constituent elements are fixed in the case.

4. The hybrid speaker of claim 3, wherein, as a curled portion of the case contacts the PCB, the conductive ring is electrically connected to the PCB via the case.

5-8. (canceled)

9. A hybrid speaker comprising:
a vibration diaphragm having a conductive coating layer formed by coating a conductive material for forming an electrode on a surface of a polymer film and an aerogel layer formed by coating aerogel on the other surface of the polymer film;
a piezo element disposed at a surface of the vibration diaphragm, forming opposite poles with the vibration diaphragm, and generating sound pressure by a piezoelectric effect;
a PCB electrically connected to the vibration diaphragm and the piezo element and applying an external AC voltage;
a first insulation body disposed on the other surface of the vibration diaphragm opposite to the piezo element, and
a case accommodating and fixing the above constituent elements and having a sound pressure discharge hole in a surface thereof,
wherein the piezo element and the PCB are electrically connected by a conductive leaf spring disposed therebetween.

10. The hybrid speaker of claim 9, wherein the leaf spring has a ring shape and comprise a plurality of contact protrusions protrude from a lower surface to an inner upper portion to face each other, and a lower surface of the leaf spring and the contact protrusions contact the piezo element and the PCB, respectively.

11. The hybrid speaker of claim 9, wherein a second insulation body having a ring shape in which a space is formed at a center portion thereof is disposed between the piezo element and the PCB, and the leaf spring is accommodated in the space of the second insulation body and protected therein.

12. A hybrid speaker comprising:
a vibration diaphragm having a conductive coating layer formed by coating a conductive material for forming an electrode on a surface of a polymer film and an aerogel layer formed by coating aerogel on the other surface of the polymer film;
a piezo element disposed at a surface of the vibration diaphragm, forming opposite poles with the vibration diaphragm, and generating sound pressure by a piezoelectric effect;
a PCB electrically connected to the vibration diaphragm and the piezo element and applying an external AC voltage;
a first insulation body disposed on the other surface of the vibration diaphragm opposite to the piezo element, and
a case accommodating and fixing the above constituent elements and having a sound pressure discharge hole in a surface thereof,
wherein the first insulation body has a ring shape in which a space is formed at a center portion thereof.

13. The hybrid speaker of claim 10, wherein a second insulation body having a ring shape in which a space is formed at a center portion thereof is disposed between the piezo element and the PCB, and the leaf spring is accommodated in the space of the second insulation body and protected therein.
